(19) United States
(12) Patent Application Publication
(10) Pub. No.: US 2011/0197739 A1
(43) Pub. Date: Aug. 18, 2011

(54) Slip-On Guitar Or Bass Guitar Cover System

(76) Inventors: Patrick Dominic Pearce, Titusville, FL (US); Lyubov Vladimirovna Pearce, Titusville, FL (US)

(21) Appl. No.: 12/704,783

(22) Filed: Feb. 12, 2010

(51) Int. Cl. G10D 9/00; B65D 65/02

(52) U.S. Cl. 84/453; 150/162

(57) ABSTRACT

Protective, slip-on, two component cover system made of soft, absorbent material and adapted to protect the body and neck of a guitar or a bass guitar. It is preferred that the components are made of a natural, soft fiber such as cotton flannel. The body component has front, side and back sheets which are sewn together to correspond generally to the shape of a guitar or bass guitar. The body cover component has an open area to allow installation and removal of the cover with respect to a guitar or bass guitar body. The body cover component has a guitar or bass guitar pick or plectrum storage pocket. It is preferred that the neck cover component is made of the same natural, soft fiber cotton flannel and has a long sheet and, depending on the neck construction, a cap or wrap around belt which are sewn together to correspond generally to the shape of the guitar or bass guitar neck and its headstock. The neck cover component has a series of belts to allow installation and removal of the neck cover component using Velcro with respect to a guitar or bass guitar neck during instrument use.

### REFERENCES CITED

U.S. PATENT DOCUMENTS

| | | | |
|---|---|---|---|
| 4,177,847 | December 1979 | Spindler | 150/52 R |
| 4,000,678 | January 1977 | Messina | 84/453 |
| 3,877,051 | April 1975 | Toth | 150/52 R |

### BACKGROUND OF THE INVENTION

The present invention relates to a novel, slip-on cover system for guitars and bass guitars designed to protect the finish of a guitar or bass guitar against scratches or the wear and marring occurring during normal usage as well as while the instrument is on display.

It is well known that the finish provided on the body and neck of a guitar or bass is subject to marring, scratching and general wear during the playing thereof due to moisture and friction from the player's hand, friction against belt buckles, stands, wall hangers, other display devices and the like. Protective jackets for string instruments are shown in several patents including U.S. Pat. Nos. 4,177,847, Dec. 11, 1979 to Spindler; 3,877,501, Apr. 15, 1975, to Toth; 4,000,678, Jan. 4, 1977, to Messina.

It is an object of the present invention to provide a novel and improved guitar and bass guitar cover system. More specifically, it is an object of the present invention to provide a guitar and bass guitar cover system components for both the body and the neck made of soft, washable, natural fiber material adapted to slip on and off the body and neck of a guitar or bass guitar having a plurality of control knobs. Yet another object of the present invention is to provide guitar or bass guitar body and neck components which are capable of absorbing moisture such as that associated with a musician's hand and yet which effectively protects the body and neck from scratching or marring. Still another object is to provide guitar or bass guitar body and neck components which are easily slipped onto the body and neck and yet are securely attached thereto. Additionally, another object of the present inventions is that no removal of strings, control knobs, etc. are required for installation and use. These and other features, objects, and advantages of the present invention will be apparent from the following description and appended claims taken in conjunction with the accompanying drawings.

### BRIEF DESCRIPTION OF THE SEVERAL VIEWS OF DRAWINGS

FIG. 1 is a full front view of both components of the guitar or bass guitar cover system of the present invention slipped onto a conventional guitar or bass guitar;

FIG. 2 is a full rear view of both components of the guitar or bass guitar cover system of the present invention slipped onto a conventional guitar or bass guitar;

FIG. 3 is a full front view of the neck component cover of the present invention with a Headstock cap;

FIG. 4 is a front perspective view of the body component cover of the present invention; and

FIG. 5 is a full rear view of the neck component cover of the present invention with an alternative strap on the Headstock;

FIG. 6 is a rear perspective view of the body component cover of the present invention.

### DESCRIPTION OF THE INVENTION

The present invention relates to a protective cover system for guitars or bass guitars especially adapted to protect the body and neck of a guitar or bass guitar from moisture and friction due to a musician's hand or arm and from scratching or other marring which might be affected by guitar or bass guitar displays, wall hangers, stands, belt buckles, pant divots, buttons, zippers or the like. It will be appreciated that the guitar or bass guitar body cover component of the present invention is intended to serve its protective function primarily during times of use of the instrument. It will also be appreciated from the following disclosure that the present invention is well calculated to protect the body and neck portions of the guitar or bass guitar while also offering a cover system which is easily slipped onto a guitar or bass guitar and yet which remains securely attached once slipped thereon. Also, the components of this invention are economically constructed and made of washable material so as to allow easy cleaning or washing thereof. In addition, the guitar or bass guitar cover body component provides a facility for pick or plectrum storage. Finally, neither of the guitar or bass guitar cover body and/or neck components require the removal of strings, control knobs, etc to facilitate their installation.

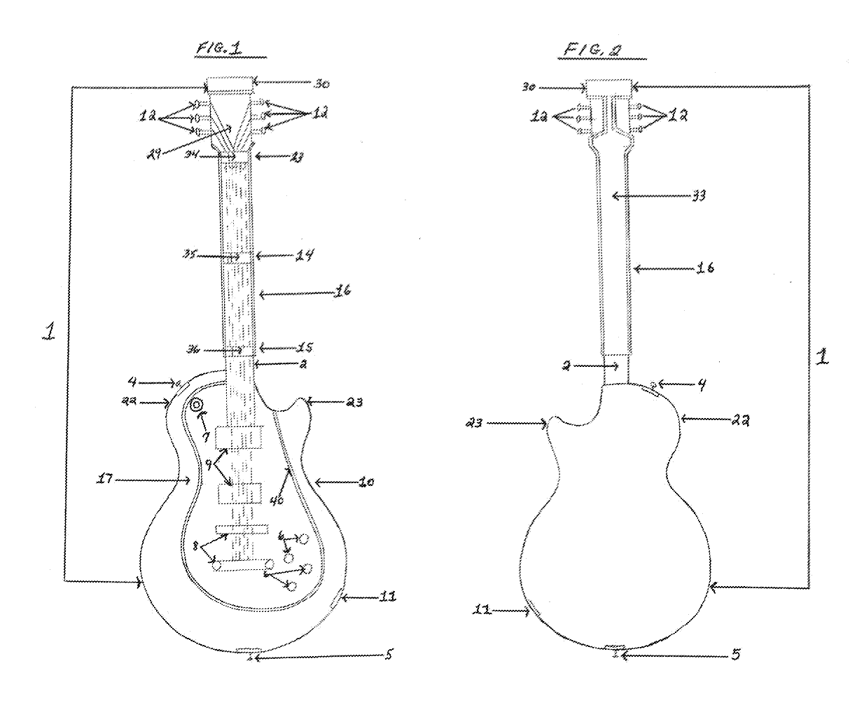

Now referring to the figures, FIG. 1 shows the guitar body or bass guitar cover component of the present invention, indicated generally by the numeral 10, in full frontal operating position on a conventional guitar or bass guitar. Guitar or bass guitar 1 has a body 3 with a neck 2 extending there from, and has means for attaching a guitar or bass guitar strap shown at 4 and 5. Extending from the front of the body 3 is a series of control knobs 6 and, depending on body style, a control knob 7. The body 3 also has a bridge portion for mounting the bridge 8 and up to three electromagnetic pickups 9 which are proximate to the portion of the strings that are picked or otherwise manipulated to generate musical tones. FIG. 1 shows the guitar or bass guitar neck cover component of the present invention, indicated generally by the numeral 16, in full frontal operating position on a conventional guitar or bass guitar. Guitar or bass guitar 1 has a body 3 with a neck 2 extending there from, and has means for attaching a guitar or bass guitar strap shown at 4 and 5. Extending from the front of the body 3 is a series of control knobs 6 and, depending on body style, a control knob 7. FIG. 2 shows the guitar or bass guitar neck cover component of the present invention, indicated generally by the numeral 16, in full rear operating position on a conventional guitar or bass guitar.

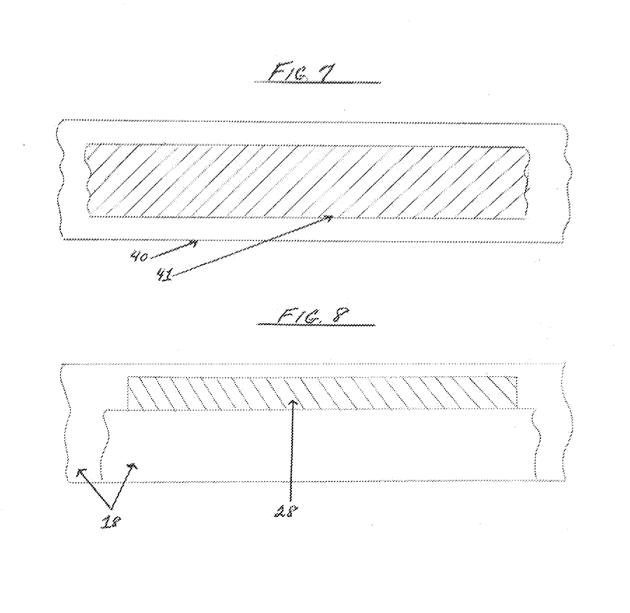

As shown in FIGS. 4 and 5, guitar or bass guitar body component cover 10 generally comprises front sheets 17, in double layers, side sheets 18 and 27 in double layers, and bottom sheet 19 in double layers which are sewn to each other at respective adjacent edge portions. It will be appreciated by those skilled in the art that side sheets 18 and 27 can be integrally formed or can comprise of a single double layer sheet or two double layer sheets sewn together proximate to carrying strap attachment means 5 as shown in FIG. 1.

As shown in FIGS. 4 and 6, a slit 20 is provided at the juncture of side sheets 18 and 27 through which extends the guitar or bass guitar strap attachment means 5. As shown in FIGS. 4 and 6, a slit 21 is provided at the upper end of side sheet 18 through which extends the guitar or bass guitar strap attachment means 4.

The exact shape of front, side and back sheets 17, 18, and 19 is, of course, dependent upon the shape of the body 3 of the particular guitar or bass guitar to which guitar or bass guitar body component cover 10 is to be attached. Front and back sheets 17 and 19 have outer perimeter edges corresponding to the outer shape of the guitar or bass guitar body 3 and might have, for example, a maximum width of about 14 inches and a maximum length of about 20 inches. Side sheet 18 conforms to the side portion of the guitar or bass guitar body and might have a width of about two to three inches and a length great enough to extend around the body 3 and form shoulder portions 22 and 23 which fittingly receive corresponding shoulders of the body 3 and assist in securing guitar cover 10 to the body 3. The body points 24, 25 and 26 of side sheet 18 and 25 can have reinforcement inserts 28 between each layer of cotton fabric sewn thereto as shown in FIG. 8.

Front sheet 17 has a large, generally U-shaped open area 36 therein which is adapted to expose bridge portion 8 and the series of control knobs 16 to allow use of guitar or bass guitar 3 with guitar or bass guitar cover 1 attached. A slit, 11, is provided along side sheet 27 which, depending on the model of guitar or bass guitar, facilitates connecting the instrument input jack to an external amplification source. In addition, front sheet 17 has a decorative fabric based trim 40 which also acts as a channel for an internally inserted elastic band to maintain guitar cover 10 tightly against the body 3; a cutaway view of which is shown in FIG. 7. Moreover, a pick or plectrum storage pocket 42 is provided to the musician and, depending upon the body cover component style, is attached either along side sheet 26 proximate to the control knob 7 at 43 or on the front sheet 17 proximate to the strap attachment 4 at 44.

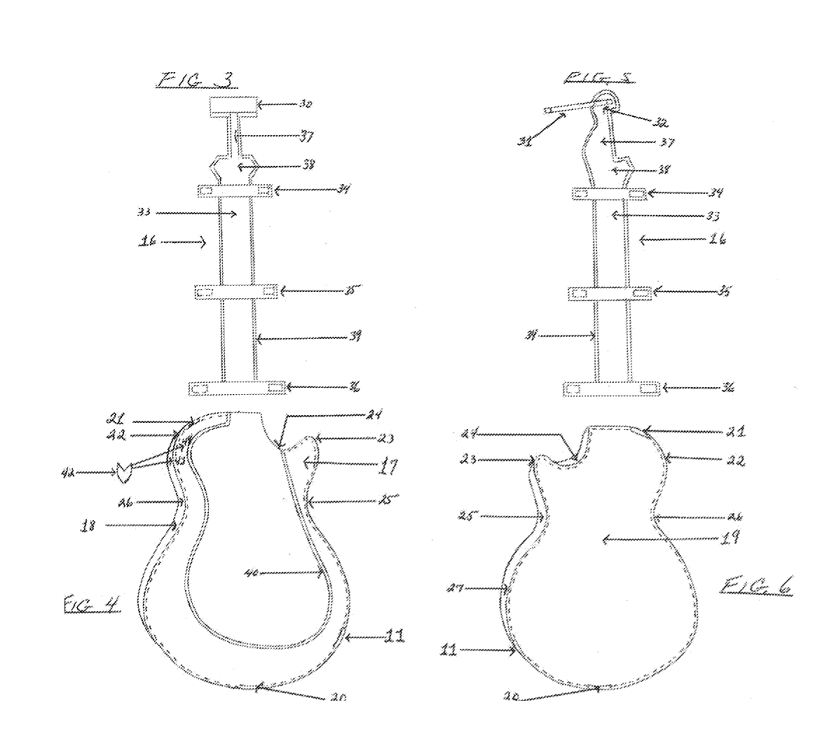

Again referring to the figures, FIGS. 1 and 2 show the neck component of the present invention, indicated generally by the numeral 16, in operating position on a conventional guitar or bass guitar 1. FIGS. 3 and 5 show the neck component of the present invention, indicated generally by the numeral 16, prior to installation. Depending on the shape of the guitar or bass guitar Headstock 29, a cotton fabric protective cap 30 or small fabric belt 31 utilizing Velcro 32 may be implemented in securing the upper neck component to the instrument Headstock 29. The neck component may be constructed of two sections of cotton fabric, depending upon the model of the guitar or bass guitar, with varying Headstock 29 sizes and varying neck sheet 33 lengths, sewn together with its seam concealed by the first neck component soft fabric Velcro belt 9. Additionally, the neck component is also comprised of at least three soft fabric and Velcro belts 34, 35, and 36 positioned at the first fret 13 of the neck, approximate midpoint 14, and end point 15 respectively which are used to secure the length of sheet 33 to the neck. FIGS. 3 and 5 also show a section 37 of the Headstock 29 which, depending upon the model of the guitar or bass guitar, runs between or adjacent to the instrument string tuning keys 12 terminating in a Y-shape or half Y-shape 38 and is implemented to protect the Headstock 29 from potential finish damage by instrument stands or wall hanging display devices. A decorative fabric trim 39 is sewn to the perimeter of the neck component which matches in color with the decorative trim 40 of the body component.

What is claimed:

1. A two component slip-on cover system for protecting both the body and neck of a guitar or a bass guitar, said body cover component comprising: a front sheet, a side sheet and a back sheet, each comprising a double layer soft absorbent cotton flannel cloth material and each of said front, side and back sheets being sewn together at adjacent perimeter edge portions; and said neck cover component comprising: a long sheet, a Headstock sheet and at least three fabric belts of soft absorbent cotton flannel cloth material and said long sheet and Headstock sheet being sewn together at mid point of the first neck belt.

2. A slip-on body component cover as recited in claim 1 wherein said side sheet comprises two side double layer sheet portions with end portions sewn together or said side sheet comprises one double layer side sheet portion with end portions sewn together.

3. A slip-on body component cover as recited in claim 1 wherein said front sheet or side sheet has a sewn guitar or bass guitar pick or plectrum storage pocket.
